(19) United States
(12) Patent Application Publication
(10) Pub. No.: US 2016/0329788 A1
(43) Pub. Date: Nov. 10, 2016

(54) SHAFTLESS GENERATOR

(71) Applicant: Sergey OSTROUKHOV, Onchan, Isle of Man (GB)

(72) Inventor: Sergey OSTROUKHOV, Onchan, Isle of Man (GB)

(21) Appl. No.: 15/108,467

(22) PCT Filed: Dec. 29, 2014
(86) PCT No.: PCT/GB2014/053852

§ 371 Date: Jun. 27, 2016

(30) Foreign Application Priority Data
Dec. 27, 2013 (GB) 1323059.4

(51) Int. Cl. H02K 21/12; H02K 1/27; H02K 1/17; H02K 7/09; H02K 1/22

(52) U.S. Cl. CPC H02K 21/12; H02K 7/09; H02K 1/223; H02K 1/17; H02K 1/2786; H02K 1/2706

(57) ABSTRACT

A magnetic generator (1) comprising a stator (3), a rotor (5) having an axis of rotation (7); a source of torque to cause rotation of the rotor about the stator; a first set of one or more magnets (9) provided on the stator (3); and a second set of one or more magnets (1 1) provided on the rotor (5). Like poles of the magnets (9, 1 1) face each other and the magnets (9, 1 1) are disposed respectively on the stator (3) and the rotor (5) such that during rotation the rotor (5) is magnetically levitated in relation to the stator (3) by the magnets (9, 1 1). The rotor (5) is ring shaped and an electrically conductive coil (19) is wound around the rotor (5) such that the rotor (5) rotates inside the coil (19).

### FIELD OF THE INVENTION

The present invention relates to an electrical power generator which utilises mechanical energy to provide electrical output.

### BACKGROUND OF THE INVENTION

A typical generator includes a rotor mounted on a shaft rotatable about its longitudinal axis, a stator and magnets (permanent or electromagnets) arranged either on the rotor or the stator. Rotation of the rotor in the magnetic field induces electric current in armature which may be located either on the rotor or the stator. One inherent problem associated with this type of machine is energy losses due to friction of movable parts.

A further problem is reliance on fossil fuel or intermittent input energy sources to provide the drive torque. Attempts to address this problem have been made utilising magnetic force to produce driving force and machines capable to produce rotation using magnetic flux have been built. A magnetic motor is a device which converts magnetic force into mechanical motion. A magnetic motor operates using (at least in part) the energy of repelling magnets positioned on rotor and stator parts of the motor to induce rotation of the rotor. The mechanical output of the rotor can either be utilised without further conversion, i.e. the magnetic motor can be used as a mechanical drive, or converted into electric power by supplying the mechanical output of the motor to an electromagnetic generator. Such machines are described, for example, in WO2006/045333 (Brady), EP 0256132 B1 (Minato) and GB2282708 B (Adams). WO2006/045333 utilise permanents magnets to produce rotation, whilst GB 2282708 uses a combination of electromagnets and permanent magnets. EP 0256132 B1 uses permanent magnets to produce rotation and electromagnets for braking. Whilst providing cleaner power, this type of machine has a relatively complex configuration.

The object of the present invention is to provide a generator with increased useful output, reduced complexity, reduced overall weight and reduced susceptibility to wear and tear compared to prior art.

### SUMMARY OF THE INVENTION

According to a first aspect of the invention there is provided a generator comprising:
a stator;
a rotor having an axis of rotation;
a source of torque to cause rotation of the rotor about the stator
a first set of one or more magnets provided on the stator;
a second set of one or more magnets provided on the rotor;
wherein like poles of the magnets of the first and second sets face each other and the magnets of the first and second sets are disposed respectively on the stator and the rotor such that during rotation the rotor is magnetically levitated in relation to the stator by the magnets of the first and second set; and
wherein an electrical conductor is disposed in a space between the stator and the rotor such that electric current is induced in the conductor during rotation of the rotor.

In the present invention, in use, the rotor is suspended in relation to the stator solely due to the repulsion of the magnets of the first and second set whereby the rotor is levitated by the magnets of the first and second set and no other support, other than the magnetic force is required to keep the rotor suspended during rotation of the rotor. Thus, the magnets on the rotor and the stator serve as a radial magnetic bearing for the rotor and the rotor does not require a shaft to be rotatably mounted in relation to the stator.

Preferably, the rotor is substantially ring shaped.

Preferably the electrical conductor comprises an electrically conductive coil.

Preferably, the coil is arranged around the rotor such that the rotor is levitated with respect to the coil as well as with respect to the stator.

Preferably, the coil is wound around the rotor. Preferably, in use, the rotor rotates inside the coil.

Preferably, the coil includes at least one and, more preferably, a plurality of windings.

Preferably, the coil is wound around the rotor in a generally toroidal configuration such the rotor forms a core of the coil. Such an arrangement of the coil is not possible with a shaft mounted rotor. Such an arrangement of the coil provides for a more efficient current induction.

It will be appreciated that the term “toroidal configuration” should be afforded a broad meaning including a fully or a partially toroidal general shape, including instances with only one winding as well as a plurality of windings. It will also be appreciated that the term winding should be understood to include a full as well as a partial winding.

The coil may be supported on the stator or by a structure external to the stator.

The ring shape of the rotor facilitates the magnetic levitation of the rotor by the magnets of the stator and the rotor during rotation of the rotor and the accommodation of the coil in the space between the stator and the rotor.

Preferably the ring comprises an annular band which defines a central opening. Preferably, the band has a width (i.e. the difference between the outer radius of the annular band and the radius of the central opening) smaller than the radius of the central opening, and, preferably, at least two times or more, smaller than the radius of the central opening.

The magnets of the first and second sets may be permanent magnets, such as, for example, but not limited thereto, neodymium (Nd—Fe—B) or samarium-cobalt (Sm—Co) magnets. The first set of magnets may include electromagnets.

The magnets of the first and/or the second sets are preferably electrically insulated from the stator and the rotor, respectively, to prevent eddy currents spreading from the magnets into the material of the stator and/or the rotor.

The rotor and/or the stator may be made from a non-magnetic material.

Preferably, the space between the rotor and the stator includes a gap defined between the stator and the rotor and the magnets of the first and the second sets are disposed, respectively, on the stator and the rotor so as to create a radial (in relation to the axis of rotation of the rotor) magnetic flux field in the gap.

In a preferred arrangement, the or each magnet of the first set is disposed on a substantially radially (in relation to the axis of rotation of the rotor) facing surface of the stator facing the gap. The substantially radially facing surface of the stator facing the gap may be a radially inwardly facing surface. Preferably, the or each magnet of the second set is disposed on a substantially radially facing (in relation to the axis of rotation of the rotor) face of the rotor, facing the gap. The substantially radially facing surface of the rotor facing the gap may be a radially outwardly facing surface.

In a preferred arrangement, the first set includes a plurality of magnets. Preferably, the magnets of the first set are circumferentially spaced around the radially facing surface of the stator facing the gap. The second set preferably includes a plurality of magnets. Preferably, the magnets of the second set are circumferentially spaced around the radially facing surface of the rotor facing the gap.

In a preferred arrangement the stator surrounds the rotor.

Preferably, the generator comprises a stabilising arrangement to prevent the rotor from linear displacement during rotation, including axial and radial displacement (in relation to the axis of rotation of the rotor). The stabilising arrangement may be provided on the stator. The stabilising arrangement may include one or more restricting members. The restricting members may be provided around an outer circumference of the rotor to prevent radial displacement of the rotor. The restricting members may be provided at axially opposite sides of the rotor to prevent axial displacement. The coil is preferably adapted to function as an additional or alternative stabilising arrangement. A coil wound around the rotor into a toroidal configuration provides an advantageous stabilising arrangement.

The coil is preferably couplable to a consumer electric circuit, which may include a transformer or a distribution unit.

The rotor and the stator may be accommodated in a protective enclosure. The protective enclosure may be a vacuum enclosure to eliminate or minimise air resistance during rotation of the rotor.

Preferably, the axis of rotation of the rotor is substantially horizontal.

Preferably, the generator includes an actuation arrangement for initiating and terminating the rotation and levitation of the rotor. In one embodiment, the actuation arrangement is preferably adapted to move the rotor and/or the stator into engagement with each other to enable the rotation and levitation of the rotor and out of engagement to stop the rotation and levitation of the rotor. Alternatively or additionally, the or each magnets of the first and/or the second set may be movably arranged, respectively, on the stator and the rotor to create or remove the magnetic flux required to levitate the rotor.

Accordingly, the only moving working part in the magnetic generator of the present invention is the rotor. Moreover, the rotor is shaftless thereby minimising the number of component parts of the generator and thus reducing weight, complexity, wear and tear and overall cost of manufacture and maintenance of the generator of the invention. Due to its ring shape, the rotor is lighter and less cumbersome than prior art shaft-mounted rotors, thereby further helping to reduce the overall weight and manufacturing costs of the generator.

Since the present invention eliminates the need for a shaft, no bearings are required to support a shaft and the problem of energy losses due to friction does not arise. The absence of friction also helps to reduce heating and thus prevents demagnetisation of the magnets.

The absence of a shaft results in reduced complexity, fewer component parts, less wear and tear and, lower cost. Accordingly, the present invention provides a generator which is efficient and reliable, yet simple, relatively inexpensive and portable.

The generator of the present invention can be easily installed where required to produce electric power in situ. The generator of the present invention can be used on land or on vehicles, including ground or marine vehicles. The generator of the present invention can be used as a back-up system in case of grid power supply failure or indeed in combination with weather dependent power generations means (e.g. wind or solar generators). Numerous other industrial and domestic uses of the generator of present invention will be readily apparent to a person skilled in the art.

In one arrangement, the source of torque to cause rotation of the rotor about the stator comprises the magnets of the first and second sets, wherein like poles of the magnets of the first and second sets face each other such that repulsion between the magnets of the first and second sets causes rotation of the rotor about the stator.

In one arrangement, the source of torque to cause rotation of the rotor comprises electromagnets provided on the stator, and, preferably, connected to an alternating current source for energizing the electromagnets.

The source of torque to cause rotation of the rotor may include a combination of electromagnets on the stator and permanent magnets of the first and second sets. The electromagnets are preferably connected to an alternating current source for energizing the electromagnets. The electromagnets may be used to provide initial torque, braking, and to control and correct the rotation and/or levitation of the rotor.

The source of torque may also be provided by other arrangements, such as, for example, mechanical sources, e.g. a turbine or a combustion engine.

According to a second aspect of the invention there is provided a method of generating electricity, the method comprising the steps of:
(a) providing a generator comprising:
a stator;
a rotor having an axis of rotation;
a first set of one or more magnets provided on the stator;
a second set of one or more magnets provided on the rotor;
wherein like poles of the magnets of the first and second sets face each other and the magnets of the first and second sets are disposed respectively on the stator and the rotor such that during rotation the rotor is magnetically levitated in relation to the stator by the magnets of the first and second set;
wherein an electrical conductor disposed in a space between the stator and the rotor such that electric current is induced in the conductor during rotation of the rotor; and wherein the rotor is substantially ring shaped and the electrical conductor comprises an electrically conductive coil wound around the rotor; and wherein the rotor is shaftless;
b) applying torque to the rotor to cause rotation of the rotor about the stator and suspending the rotor in relation to the stator solely due to the repulsion of the magnets of the first and second set such that no other support, other than the magnetic force is required to keep the rotor suspended during rotation of the rotor.

The method may include causing rotation of the rotor about the stator by the magnets of the first and second sets wherein like poles of the magnets of the first and second sets face each other such that repulsion between the magnets of the first and second sets causes rotation of the rotor about the stator.

The method may include providing electromagnets on the stator and connected to a current source, and causing rotation of the rotor about the stator by energizing the electromagnets.

The method may include causing rotation of the rotor about the stator by using a combination of electromagnets on the stator and connected to a current source for energizing the electromagnets and permanent magnets of the first and second sets. The electromagnets may be used to provide initial torque, braking, and to control and correct the rotation and/or levitation of the rotor.

All essential, preferred or optional features of the first aspect of the present invention can be provided in conjunction with the second aspect of the present invention and vice versa where appropriate.

### DETAILED DESCRIPTION OF THE INVENTION

Embodiments of the present invention will now be described, by way of example only, with reference to the accompanying drawings in which:

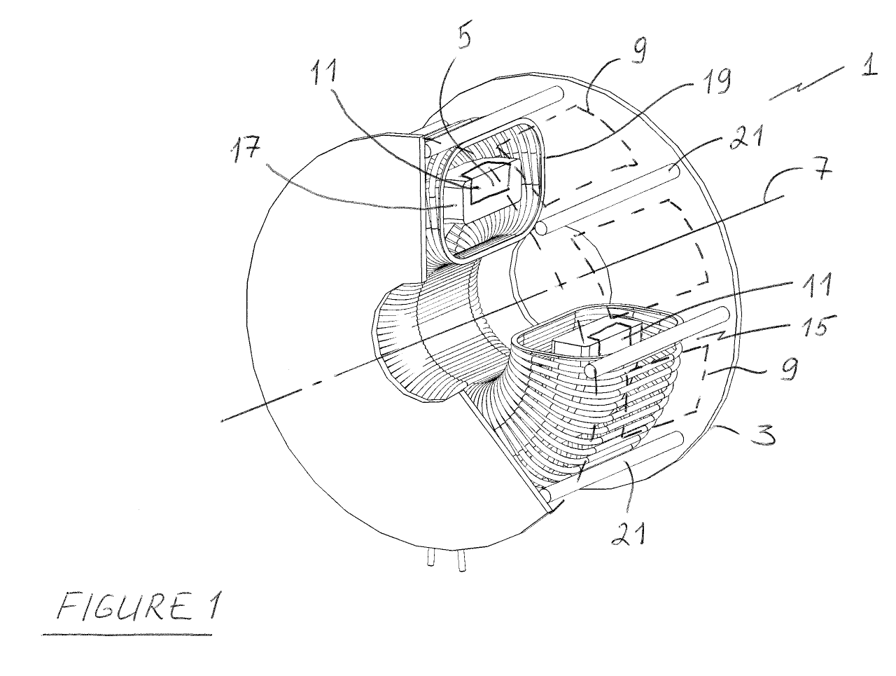

FIG. 1 is a schematic perspective cutaway view of a generator in accordance with the present invention;

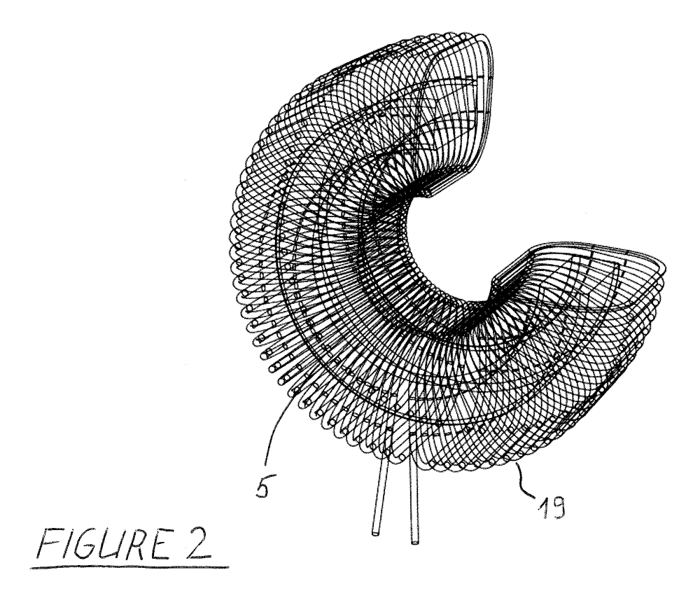

FIG. 2 is a schematic perspective view of a coil wound around a rotor of the generator of FIG. 1; and

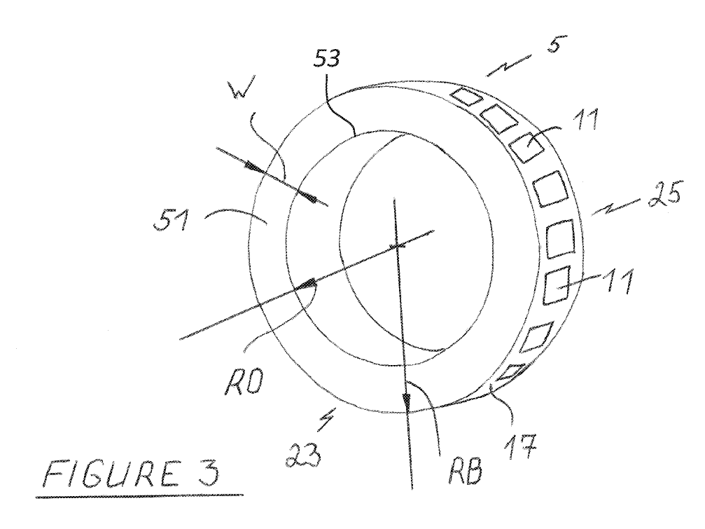

FIG. 3 is a schematic perspective view of the rotor of FIGS. 1 and 2.

Referring to FIGS. 1 to 3, a generator of the invention is generally indicated by reference numeral 1. The generator 1 comprises a stator 3 which encloses a ring shaped rotor 5. The rotor 5 has a substantially horizontal axis 7 of rotation. A first set of magnets 9 (shown in phantom lines) is provided on the stator 3 and a second set of magnets 11 is provided on the rotor 5. The magnets 9, 11 may be permanent magnets, for example, neodymium (Nd—Fe—B) or samarium-cobalt (Sm—Co) magnets. The magnets 9 of the first set may include electromagnets.

A space between the stator 3 and the rotor 5 includes a gap 15 defined between a radially inwardly (in relation to the axis 7 of rotation of the rotor 5) facing surface (not indicated by a numeral) of the stator 3 and an outwardly (in relation to the axis 7 of rotation of the rotor 5) facing surface 17 of the rotor 5. The stator magnets 9 are circumferentially spaced around the inwardly facing surface of the stator 9 so as to face the gap 15. The rotor magnets 11 are also circumferentially spaced around the outwardly facing surface 17 of the rotor and also face the gap 15. Thus, the magnets 9, 11 of the first and the second sets are disposed, respectively, on the stator 3 and the rotor 5 so as to create a radial (in relation to the axis 7 of rotation of the rotor 5) magnetic flux field in the gap 15. The magnets 9, 11 are arranged on the stator 3 and the rotor 5, respectively, such that like poles of the magnets 9, 11 face each other (i.e. magnets 9 and magnets 11 repel each other around the entire circumferences of the stator 3 and the rotor 5). The radial magnetic flux field created in the gap 15 by the repelling like poles of the magnets 9, 11 causes the rotor 5 to be magnetically levitated within the stator 3 during rotation. The ring shape of the rotor 5 facilitates levitation.

An electrical conductor provided in the form of electrically conductive coil 19 is disposed in the space between the stator 3 and the rotor 5 such that electric current is induced in the coil 19 during rotation of the rotor 5. In the presently described embodiment, the coil 19 includes a plurality of windings and is wound around the rotor 5 into a toroidal configuration such the rotor 5 forms a core of the coil 19 and, in use, rotates inside the coil.

The rotor 5 is levitated within the stator 3 solely due to the repulsion of the magnets 9, 11 and no other support is required to keep the rotor 5 suspended during rotation of the rotor 5.

The ring shaped rotor 5 comprises an annular band 51 which defines a central opening 53. The band 51 has a width W (i.e. the difference between the outer radius RB of the annular band 51 and the radius RO of the central opening 53) two times or more smaller than the radius RO of the central opening 53 to facilitate the levitation on the rotor 5 and the accommodation of the coil 19 in the space between the stator 3 and the rotor 5.

The generator 1 includes a stabilising arrangement to prevent the rotor 5 from linear displacement during rotation, including axial and radial displacement (in relation to the axis 7 of rotation of the rotor 5). The stabilising arrangement includes a plurality of restricting members 21 provided on the stator 3 around an outer circumference of the rotor 5 to prevent radial displacement of the rotor 5. Although not shown in the drawings, further restricting members may be provided at axially opposite sides 23, 25 of the rotor 5 to limit axial displacement of the rotor 5. The toroidal coil 19 wound around the rotor 5 also functions as an additional or alternative stabilising arrangement.

Although not shown in the drawings, the coil 19 may be supported by the stator 3 or by another support arrangement external to the stator 3.

Although not shown in the drawings, the magnets 9, 11 are preferably electrically insulated from the stator 3 and/or the rotor 5, respectively, to prevent eddy currents in the magnets 9, 11 from spreading into the materials of the stator 3 and/or the rotor 5.

The rotor 5 and/or the stator 3 are preferably made from a non-magnetic material.

Although not shown in the drawings, the coil 19 is couplable to a consumer electric circuit, which may include a transformer or a distribution unit.

Although not shown in the drawings, the rotor 5 and the stator 3 may be accommodated in a protective enclosure. The protective enclosure may be a vacuum enclosure to eliminate or minimise air resistance during rotation of the rotor 5.

Although not shown in the drawings, the generator 1 may include an actuation arrangement for initiating and terminating the rotation and/or levitation of the rotor 5. The actuation arrangement may be adapted to move the rotor 5 and/or the stator 3 into engagement with each other to enable the rotation and levitation of the rotor 5 and out of engagement to stop the rotation and levitation of the rotor 5. Alternatively or additionally, the or each magnets 9, 11 may be movably arranged on the stator 3 and/or the rotor 5, respectively, to create or remove the magnetic flux required to levitate the rotor 5.

Due to the provision of the rotor 5 and the shape of a ring and the levitation of the rotor 5 during rotation, the rotor 5 is the only moving working part in the magnetic generator 1 of the present invention. The rotor 5 is shaftless and thus the number of component parts of the generator 1 is considerably reduced compared to a prior art generator with a shaft mounted rotor. Thus, weight, complexity, wear and tear and the overall cost of manufacture and maintenance of the generator 1 of the invention are reduced. Due to the ring shape, the rotor 5 is lighter and less cumbersome than prior art shaft-mounted rotors, thereby further helping to reduce the overall weight and manufacturing costs of the generator. Since the present invention eliminates the need for a shaft, no bearings are required to support a shaft and the problem of energy losses due to friction does not arise. The absence of friction also helps to reduce heating of the generator 1 and thus prevents demagnetisation of the magnets 9, 11.

The absence of a shaft results in reduced complexity, fewer component parts, less wear and tear and, lower cost. Accordingly, the present invention provides a magnetic generator 1 which efficient and reliable, yet simple, relatively inexpensive and portable.

In one arrangement, rotation of the rotor 5 about the stator 3 may be caused by the permanent magnets of the first and second sets, wherein repulsion between the mutually facing like magnetic poles of the permanent magnets causes the rotor 5 to rotate about the stator 3.

In one arrangement, electromagnets included in the first set of magnets 9 on the stator 3 may provide a source of torque to cause rotation of the rotor 5. The electromagnets may be connected to an alternating current source (not shown) for energizing the electromagnets.

In another arrangement, the source of torque to cause rotation of the rotor 5 comprises a combination of electromagnets on the stator 3 and permanent magnets of the first and second sets. The electromagnets may be connected to an alternating current source for energizing the electromagnets. The electromagnets may be used to provide initial torque, braking, and to control and correct the rotation and/or levitation of the rotor 5.

Whilst specific embodiments of the present invention have been described above, it will be appreciated that modifications are possible within the scope of the present invention as defined in the appended claims.

1. A generator comprising:
a stator;
a rotor having an axis of rotation;
a source of torque to cause rotation of the rotor about the stator;
a first set of one or more magnets provided on the stator;
a second set of one or more magnets provided on the rotor;
wherein like poles of the magnets of the first and second sets face each other and the magnets of the first and second sets are disposed respectively on the stator and the rotor such that during rotation the rotor is magnetically levitated in relation to the stator by the magnets of the first and second set;
wherein an electrical conductor is disposed in a space between the stator and the rotor such that electric current is induced in the conductor during rotation of the rotor; and
wherein the rotor is substantially ring shaped and the electrical conductor comprises an electrically conductive coil wound around the rotor; wherein the rotor is shaftless and, in use, the rotor is suspended in relation to the stator solely due to the repulsion of the magnets of the first and second set such that no other support, other than the magnetic force is required to keep the rotor suspended during rotation of the rotor.

2. The generator as claimed in claim 1, wherein the coil is wound around the rotor in a generally toroidal configuration such that the rotor forms a core of the coil.

3. The generator as claimed in claim 1, wherein the magnets of the first set and second set are permanent magnets.

4. The generator as claimed in claim 1, wherein the space between the rotor and the stator includes a gap defined between the stator and the rotor and the magnets of the first and the second sets are disposed, respectively, on the stator and the rotor so as to create a radial, in relation to the axis of rotation of the rotor, magnetic flux field in the gap.

5. The generator as claimed in claim 4, wherein each magnet of the one or more magnets of the first set is disposed on a substantially radially facing surface of the stator facing the gap and each magnet of the one or more magnets of the second set is disposed on a substantially radially facing face of the rotor, facing the gap.

6. The generator as claimed in claim 5, wherein the first set includes a plurality of magnets and the magnets of the first set are circumferentially spaced around the radially facing surface of the stator facing the gap.

7. The generator as claimed in claim 5, wherein the second set includes a plurality of magnets and the magnets of the second set are circumferentially spaced around the radially facing surface of the rotor facing the gap.

8. The generator as claimed in any preceding claim 1, wherein the stator surrounds the rotor.

9. The generator as claimed in any preceding claim 1, wherein the generator comprises a stabilising arrangement to prevent the rotor from linear displacement during rotation, including axial and radial displacement in relation to the axis of rotation of the rotor.

10. The generator as claimed in claim 9, wherein the stabilising arrangement is provided on the stator.

11. The generator as claimed in claim 9, wherein stabilising arrangement includes one or more restricting members.

12. The generator as claimed in claim 11, wherein the restricting members are provided around an outer circumference of the rotor to prevent radial displacement of the rotor.

13. The generator as claimed in claim 11, wherein the restricting members are provided at axially opposite sides of the rotor to prevent axial displacement.

14. The generator as claimed in claim 1, wherein the coil is adapted to function as a stabilising arrangement to prevent the rotor from linear displacement during rotation, including axial and radial displacement in relation to the axis of rotation of the rotor.

15. The generator as claimed in claim 1, wherein the coil is supported on the stator or by a structure external to the stator.

16. The generator as claimed in claim 1, wherein the axis of rotation of the rotor is substantially horizontal.

17. The generator as claimed in any preceding claim 1, wherein the generator includes an actuation arrangement to initiate and terminate the rotation and/or levitation of the rotor.

18. The generator as claimed in claim 17, wherein the actuation arrangement is adapted to move the rotor and/or the stator into engagement with each other to enable the rotation and levitation of the rotor and out of engagement to stop the rotation and levitation of the rotor.

19. The generator as claimed in claim 17, wherein each magnet of the one or more magnets of the first set and/or each magnet of the one or more magnets of the second set are movably arranged, respectively, on the stator and the rotor to create or remove the magnetic flux required to levitate the rotor.

20. The generator as claimed in claim 1, wherein the source of torque to cause rotation of the rotor about the stator comprises the magnets of the first set and second set wherein like poles of the magnets of the first set and second set face each other such that repulsion between the magnets of the first set and second set causes rotation of the rotor about the stator.

21. The generator as claimed in claim 1, wherein the source of torque to cause rotation of the rotor comprises electromagnets provided on the stator.

22. The generator as claimed in claim 1, wherein the source of torque to cause rotation of the rotor comprises a combination of electromagnets on the stator and permanent magnets of the first set and second set.

23. A method of generating electricity, the method comprising the steps of:
(a) providing a generator comprising:
a stator;
a rotor having an axis of rotation;
a first set of one or more magnets provided on the stator;
a second set of one or more magnets provided on the rotor;
wherein like poles of the magnets of the first and second sets face each other and the magnets of the first and second sets are disposed respectively on the stator and the rotor such that during rotation the rotor is magnetically levitated in relation to the stator by the magnets of the first and second set;
wherein an electrical conductor is disposed in a space between the stator and the rotor such that electric current is induced in the conductor during rotation of the rotor; and
wherein the rotor is substantially ring shaped and the electrical conductor comprises an electrically conductive coil wound around the rotor; and wherein the rotor is shaftless; and
b) applying torque to the rotor to cause rotation of the rotor about the stator and suspending the rotor relation to the stator solely due to the repulsion of the magnets of the first and second set such that no other support, other than the magnetic force is required to keep the rotor suspended during rotation of the rotor.

24. The method as claimed in claim 23, comprising the step of causing rotation of the rotor about the stator by the magnets of the first set and second set wherein like poles of the magnets of the first set and second set face each other such that repulsion between the magnets of the first set and second set causes rotation of the rotor about the stator.

25. The method as claimed in claim 23, comprising the steps of:
providing electromagnets on the stator and connected to a current source; and
causing rotation of the rotor about the stator by energizing the electromagnets.

26. The method as claimed in claim 23, comprising the steps of:
providing permanent magnets in the first set and second set;
providing electromagnets on the stator;
connecting the electromagnets to a current source for energizing the electromagnets; and
causing rotation of the rotor about the stator by a combination of the electromagnets on the stator and the permanent magnets of the first set and second set.

27. The method as claimed in claim 26, comprising the step of using the electromagnets to provide initial torque, braking, and to control and correct the rotation and/or levitation of the rotor.
